(19) United States
(12) Patent Application Publication
(10) Pub. No.: US 2008/0001700 A1
(43) Pub. Date: Jan. 3, 2008

(54) High inductance, out-of-plane inductors

(76) Inventor: Flavio Pardo, New Providence, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/479,450

(22) Filed: Jun. 30, 2006

(51) Int. Cl. H01F 5/00

(52) U.S. Cl. 336/200

(57) ABSTRACT

A high inductance, out-of-plane inductor is achieved by forming on a flat flexible base conductive elements that are arranged in a pattern such that when the flat flexible base, e.g., a polymer film, is curled, e.g., by application of heat, the conductive elements are likewise curled and opposite ends of different ones of the conductive elements are brought into conductive contact, and may be bonded, so as to form a conductive coil using at least two of the conductive elements. Additional conductors may be formed on the flexible base to act as wires to provide connections to the resulting conductive coil. A portion of the flexible base, e.g., extending beyond the coil, can serve as a base to which one or more chips, e.g., flip-chip mounted, or other components are attached.

### TECHNICAL FIELD

This invention relates to inductors, and more particularly, to high inductance, out-of-plane inductors suitable for use with integrated circuit applications.

### BACKGROUND OF THE INVENTION

As is well known, inductors may be employed in various circuits that are implemented on integrated circuits. For example, inductors may be used to increase the bandwidth of an amplifier. Inductors for use with an integrated circuit are typically implemented as either a) an in-plane, spiral inductor or b) a so-called active inductor, which uses other circuit components to simulate an inductor. The problems with using an in-plane, spiral inductor are that typically an in-plane, spiral inductor is large, and its useful frequency range is limited by self-resonance. Additionally, the magnetic field of such an in-plane, spiral inductor passes through the semiconductor substrate. This tends to induce undesired lossy eddy currents that degrade the achievable Q. The total achievable inductance is also limited by the fact that, extending outward from the center of the spiral, each turn of an in-plane, spiral inductor has a greater radius.

Although an active inductor may be relatively small, and a typical active inductor has a greater frequency range than an in-plane, spiral inductor, the conventional designs for an active inductor suffer from the problem of requiring a relatively large voltage drop, with respect to the power supply voltage, across the active inductor. With the trend in the art being toward the use of decreasing power supply voltages, to reduce power consumption, the relatively large voltage drop required to operate a prior art active inductor becomes problematic, in that it does not leave enough remaining voltage drop for the amplifying circuit coupled to the active inductor to operate properly. Furthermore, in low-power applications, such as battery powered applications, the constant use of power in an active inductor may unnecessarily drain the battery, thereby limiting the device's useful operating time for a single battery charge.

“Out-of-plane, high-Q Inductors on Low-Resistance Silicon”, by Chistpher L. Chual et al., published in the Journal of Microelectromechanical Systems, Vol. 12, No. 6, December 2003 discloses an out-of-plane, metal-based, high inductance inductor. Generally, this is achieved using a stressed metallic film that is more compressive on its lower layer and more tensile on its upper layer, so it has a natural tendency to curl, and thereby to form spring pairs that are interlocked with each other to form a complete template for coil windings. The coil windings are then electroplated with copper to form the inductor. Disadvantageously, the processing required to form the coil windings is somewhat complex. Furthermore, the coil windings must be formed on a silicon substrate. As such, the inductors cannot be manufactured as individual parts. Also, each resulting coil winding must be mechanically sound on its own, and must contain the locking mechanism, so each is relatively wide, e.g., 200 microns. To make sure that each coil winding is not short circuited, the pitch of the coil windings must be of the order of 230 microns. The foregoing limitations on width and pitch limit the number of coil windings, i.e., turns, per unit length that can be achieved, and so the total inductance that can be achieved in a given footprint is limited.

### SUMMARY OF THE INVENTION

I have recognized that a high inductance, out-of-plane inductor that is suitable for use in integrated circuit applications can be achieved, in accordance with the principles of the invention, by forming on a flat flexible base conductive elements that are arranged in a pattern such that when the flat flexible base is curled 1) the conductive elements are likewise curled and 2) opposite ends of different ones of the conductive elements are brought into conductive contact so as to form a conductive coil using at least two of the conductive elements. The flexible base may be curled by the application of heat and the ends of the conductive elements once brought into conductive contact may be bonded together. Typically, it is opposite ends of adjacent ones of the conductive elements that are brought into contact to form the conductive coil when the flexible base is curled sufficiently to form a cylinder-like shape. The conductive coil is made up of at least one, and typically more than one, so-called turns of wire. Additional conductors may be formed on the flexible base to act as wires to provide connections to the resulting conductive coil.

Typically the flexible base is a polymer film formed on a substrate at least in part over a sacrificial layer. Exemplary polymer films that are suitable for implementing the flexible base include spin-on polyimide-type polymers and Benzocyclobutene-based (BCB) polymers. Any conductive material may be used to form the conductive elements, although the conductive elements are typically metal. When metal is used to form the conductive elements, preferably high-conductivity metals such as gold, copper, and aluminum are employed. The opposite ends of the metal pattern that are brought into conductive contact may be bonded using any conventional bonding technique, e.g., using solder bumps or thermal-compression bonding, in particular when the metal employed is gold.

A portion of the flexible base, e.g., extending beyond the coil, can serve as a base to which one or more chips, e.g., flip-chip mounted, or other components are attached.

Advantageously, each wire turn may be relatively narrow as compared to the prior art, e.g., on the order of 2 microns, and the pitch of the wire turns can also be relatively smaller than the prior art, e.g., on the order of 2.3 microns. As a result, for the same unit length, an inductance 100 times larger than the prior art can be achieved.

### BRIEF DESCRIPTION OF THE DRAWING

In the drawing:

FIG. 1 shows an exemplary embodiment of an inductor, which is arranged in accordance with the principles of the invention;

FIG. 2 shows a top view of an uncurled, and possibly unreleased, exemplary inductor base with wires, contacts, and leads deposited thereon;

FIG. 3 shows a perspective view of the uncurled, and possibly unreleased, exemplary inductor base of FIG. 2;

FIG. 4 shows a perspective view of the exemplary inductor base of FIG. 2 when it has begun to curl;

FIG. 5 shows the exemplary inductor of FIG. 1 with chip mounted thereon;

FIG. 6 shows the exemplary inductor of FIG. 1 mounted on a chip; and

FIG. 7 shows the exemplary inductor of FIG. 1 but prior to bonding when that optional solder bumps are employed.

### DETAILED DESCRIPTION

The following merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any diagrams herein represent conceptual views of illustrative apparatus embodying the principles of the invention.

In the claims hereof any element expressed as a means for performing a specified function is intended to encompass any way of performing that function. This may include, for example, a) a combination of electrical or mechanical elements which performs that function or b) software in any form, including, therefore, firmware, microcode or the like, combined with appropriate circuitry for executing that software to perform the function, as well as mechanical elements coupled to software controlled circuitry, if any. The invention as defined by such claims resides in the fact that the functionalities provided by the various recited means are combined and brought together in the manner which the claims call for. Applicant thus regards any means which can provide those functionalities as equivalent as those shown herein.

Unless otherwise explicitly specified herein, the drawings are not drawn to scale.

In the description, identically numbered components within different ones of the FIGS. refer to the same components.

A high inductance, out-of-plane inductor that is suitable for use in integrated circuit applications can be achieved, in accordance with the principles of the invention, by forming on a flat flexible base conductive elements that are arranged in a pattern such that when the flat flexible base is curled 1) the conductive elements are likewise curled and 2) opposite ends of different ones of the conductive elements are brought into conductive contact so as to form a conductive coil using at least two of the conductive elements. The flexible base may be curled by the application of heat and the ends of the conductive elements once brought into conductive contact may be bonded together. Typically, it is opposite ends of adjacent ones of the conductive elements that are brought into contact to form the conductive coil when the flexible base is curled sufficiently to form a cylinder. Additional conductors may be formed on the flexible base to act as wires to provide connections to the resulting conductive coil. The flexible base can also form a base to which one or more chips, e.g., flip-chip mounted, or other components are attached.

FIG. 1 shows an exemplary embodiment of a high inductance, out-of-plane inductor, which is arranged in accordance with the principles of the invention. Shown in FIG. 1 is inductor 101, including: a) inductor base 103; b) wires 105, including wires 105-1 through 105-N; c) contacts 107, including contact 107-1 and contact 107-2; and d) leads 109, including lead 109-1 and lead 109-2.

Inductor base 103 is typically a polymer film suitable for the forming thereon of conductive elements, i.e., wires. Preferably, the polymer film making up inductor base 103 should be flexible enough so that it can be curled. To that end, it may be desirable that the coefficient of thermal expansion of the polymer film making up inductor base 103 be considerably larger than the coefficient of thermal expansion of the conductive elements that are deposited on inductor base 103 to form wires 105. If so, heating inductor base 103 and the components thereon, will cause inductor base 103 to curl, in addition to any inherent tendency that inductor base 103 may have to do so. Exemplary polymer films that are suitable for implementing the invention include spin-on polyimide-type polymers and Benzocyclobutene-based (BCB) polymers. These photo-sensitive polymers can be patterned by lithographic techniques.

Wires 105 are formed on inductor base 103. Wires 105 may be made out of any conductive material that may be adhered in the desired shape to inductor base 103. Typically wires 105 are made out of metal. In this regard, although any type of metal may be used, preferably high-conductivity metals such as gold, copper, and aluminum are employed. As is well known by those of ordinary skill in the art, films of these metals may be easily created on inductor base 103, e.g., by evaporation, and the resulting films may be patterned by lithographic techniques to form wires 105. The type of conductive material employed will largely influence the parasitic resistance inherent in a particular implementation of inductor 101.

Contacts 107 are used to electrically couple inductor 101 to other circuit components. Contacts 107 may be made out of any conductive material that may be adhered in the desired shape to inductor base 103. Contacts 107 are typically, but need not be, made of the same material as wires 105 and leads 109. Lead 109-1 couples contact 107-1 to wire 105-1 while lead 109-2 couples contact 107-2 to wire 105-N. Leads 109 may be made out of any conductive material that may be adhered in the desired shape to inductor base 103. Leads 107 are typically, but need not be, made of the same material as wires 105 and contacts 107.

Wires 105 are arranged in a pattern so that that when inductor base 105 is curled over each of wires 105 become a segment of a single wire running from lead 109-1 through lead 109-2. This single wire is the coil of inductor 101, and each of wires 105 corresponds to a turn of that coil. The inductance of inductor 101 is proportional to a) the number of turns per unit length squared, i.e., inversely proportional to the pitch squared, b) the total length of the inductor along the winding direction, and c) the cross-sectional area of the inductor. Advantageously, each wire turn may be relatively narrow as compared to the prior art, e.g., on the order of 2 microns, and the pitch of the wire turns can also be relatively small as compared with the pitch achieved by the prior art, e.g., on the order of 2.3 microns. As a result, for the same unit length, an inductance 100 times larger than the prior art can be achieved.

Inductor 101 may be made by depositing metal in a conventional manner to form wires 105 on a film that will be inductor base 105. The film is typically formed on a flat surface, and is preferably formed at least in part on a sacrificial layer that has already been deposited on a substrate. The etching away at least in part of the sacrificial layer will leave at least part of the film free to curl. The film may also be completely detached from the substrate by completely etching away the sacrificial layer.

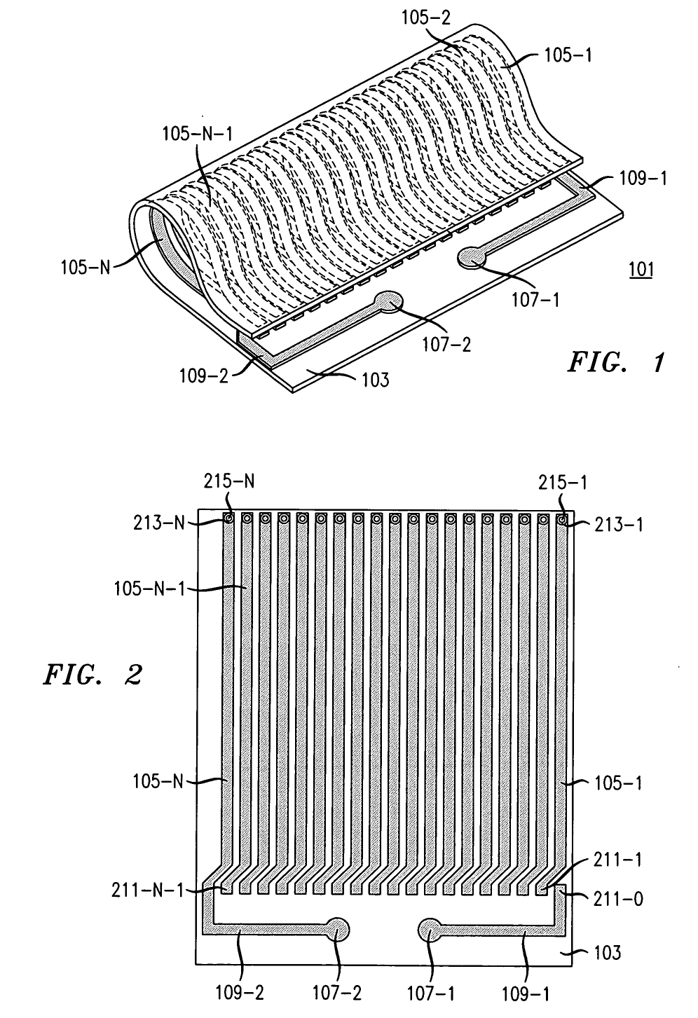

FIG. 2 shows a top view of an uncurled, and possibly unreleased, exemplary inductor base 103 with wires 105, contacts 107, and leads 109 deposited thereon. Each of wires 105 is patterned with an offset so that that when inductor base 103 is appropriately curled over the end of each of wires 105 that is located farthest from contacts 107 is positioned so that that end of the wire will make contact with the end that is closest to contact 107 of an adjacent one of wires 105. The exception to this is that wire 105-1 will make contact with lead 109-1 rather than another one of wires 105. In other words, each end 213 of one of wires 105 is aligned along with the location of an end 211 of an adjacent wire 105, except that end 213-1 is aligned with end 211-0 of lead 109.

FIG. 2 also shows optional solder bumps 215. Solder bumps 215 may be used to bond ends 213 of wires 105 to corresponding aligned ends 211 of adjacent wires 105 or end 211-0 of lead 109.

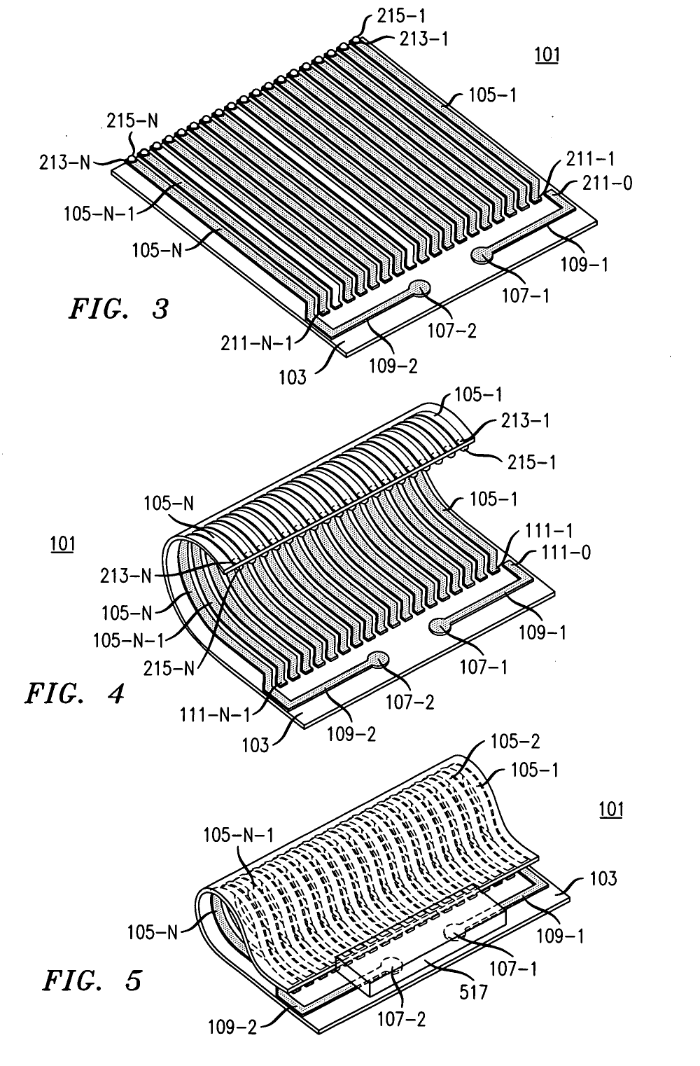

FIG. 3 shows a perspective view of the uncurled, and possibly unreleased, exemplary inductor base 103 of FIG. 2 with wires 105, contacts 107, and leads 109 deposited thereon. In FIG. 3 it is easier to see optional solder bumps 215. FIG. 4 shows a perspective view of the exemplary embodiment of FIG. 2 when at least part of the sacrificial layer (not visible) beneath inductor base 103 has been removed, so that that portion of inductor base 103 is released from the surface on which it was formed and inductor base 103 has begun to curl.

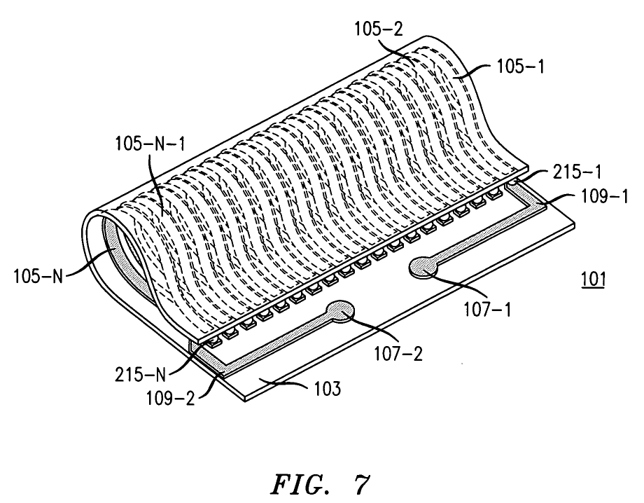

FIG. 7 shows an embodiment of inductor 101 prior to the appropriate ends being bonded when optional solder bumps 215 are employed. As shown in FIG. 7, inductor base 103 has been sufficiently released and curled so that solder bumps 215 on ends 213 of wires 105 meet the appropriate corresponding ends 211 of wires 105 or end 211-0 of lead 109-1. At this point, inductor base 101 takes at least in part a cylinder-like shape and the ends are considered to conductively meet since solder bumps 215 are conductive. In an embodiment of inductor 101 that does not employ solder bumps 215, inductor base 103 would curl ever so slightly extra to make up for the space taken up by solder bumps and ends 213 of wires 105 would directly meet the appropriate corresponding ends 211 of wires 105 or end 211-0 of lead 109-1.

The ends that meet are bonded together using any bonding technique suitable to the materials being bonded. For example, such bonding may be achieved by heating inductor 101 until optional solder bumps 215 reflow and bond the meeting ends together. Alternatively, conventional thermal-compression bonding may be employed when wires 105 and lead 109-1 are made of suitable metals, such as gold. Such thermal bonding involves applying pressure at the meeting points of the ends of the wires, which have been heated, to form a bond. The final resulting inductor 101 with bonded ends is shown in FIG. 1 as indicated. Note that if solder bumps were employed to bond the ends, they would not be visible in FIG. 1 since they reflowed. However, there would be a small layer of flattened solder at each of the bonded locations.

Note that the sacrificial layer may extend under the entirety of inductor base 103, in which case when the whole of the sacrificial layer is removed inductor 101 will become an independent component. Alternatively, if not all of the sacrificial layer is removed, or the sacrificial layer does not extend under the entirety of inductor base 103, inductor 101 will remain mounted on whatever substrate it was formed.

FIG. 5 shows inductor 101 with chip 517 mounted thereon. The circuitry of chip 517 is coupled to inductor 101 at contacts 107. To this end, chip 517 may be flip chip mounted on inductor base 103.

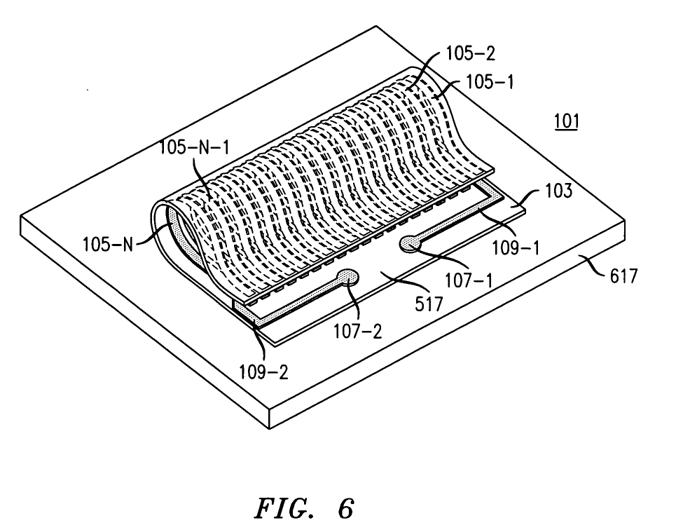

FIG. 6 shows inductor 101 mounted on chip 617. In the embodiment of FIG. 6 each of contacts 107 is formed with a via therethrough so that conductivity is established through the via from leads 109 to corresponding contacts on the chip below. Alternatively, inductor 101 could be an independent component that is mounted with contacts 107 facing chip 617.

As an example, an integrated circuit chip having a total area of the typical integrated circuit chip of 1 mm² may have circuitry formed over most of the surface area, e.g., over the entire surface area except along one edge. Preferably, only leads for connecting to the inductor should be formed in that area. A sacrificial layer is formed over the circuitry, extending over substantially the entire chip, except where the inductor base will remain in contact with the integrated circuit so that it can remain mounted thereon, which is the area in which no circuitry was formed. The inductor base is formed on top of the sacrificial layer and the area of the chip to which it will remain attached, thus having essentially the same size as the chip itself. If the uncurled wires formed on the inductor base have a width on the order of 2 microns and a pitch on the order of 2.3 microns, after curling the result inductance of the formed inductor will be on the order of 100 microHenries. As mentioned above, vias may be formed that will provide access to the inductor from leads below, or other methods of connecting to the inductor may be employed, e.g., small metal leads such as are used to make connections on integrated circuits.

What is claimed is:

1. An inductor, comprising:
a flexible base; and
a plurality of conductive segments formed in a pattern on said flexible base;
wherein at least a portion of said flexible base is curled such that opposite ends of at least two of said conductive segments meet to form a single curled wire.

2. The invention as defined in claim 1 wherein said at least two of said conductive segments meet to form a single curled wire are adjacent ones of said conductive segments.

3. The invention as defined in claim 1 further comprising at least one additional conductor formed on said flexible base that is adapted to provide a conductive connection to said single curled wire.

4. The invention as defined in claim 1 further wherein said flexible base is curled to form a cylinder-like shape.

5. The invention as defined in claim 1 wherein said flexible base is a polymer film.

6. The invention as defined in claim 5 wherein said polymer film is at least one of the group consisting of polyimide-type polymers and Benzocyclobutene-based (BCB) polymers.

7. The invention as defined in claim 1 wherein said at least two of said conductive segments are formed of at least one of the group consisting of gold, copper, and aluminum.

8. The invention as defined in claim 1 wherein said opposite ends are bonded.

9. The invention as defined in claim 8 wherein said opposite ends are bonded using solder bumps.

10. The invention as defined in claim 8 wherein said opposite ends are bonded using thermal compression.

11. The invention as defined in claim 1 further comprising at least one additional component mounted to said flexible base.

12. The invention as defined in claim 11 wherein said at least one additional component is an integrated circuit.

13. The invention as defined in claim 11 wherein at least one additional component is flip-chip mounted.

14. The invention as defined in claim 1 wherein said curled wire has a plurality of turns.

15. The invention as defined in claim 1 wherein said conductive segments are formed at least in part of metal.

16. The invention as defined in claim 1 wherein said inductor is mounted on an integrated circuit.

17. The invention as defined in claim 1 wherein said inductor is an independent component in that said flexible base is wholly released from a substrate on which it was formed.

18. The invention as defined in claim 1 wherein said inductor remains attached at least in part to a substrate on which said flexible base was formed.

19. A method for use in forming an inductor made up of a flexible base and a plurality of conductive elements formed in a pattern on said flexible base, the method comprising the steps of:
curling at least a portion of said flexible base such that opposite ends of at least two of said conductive elements meet to form a single curled wire.

20. The invention as defined in claim 19 wherein said flexible base is a polymer film.

21. The invention as defined in claim 19 wherein said curling step is performed at least until said flexible base is curled to form a cylinder-like shape.

22. The invention as defined in claim 19 wherein said curling step further comprises the step of releasing, at least in part, said flexible base from a substrate on which said flexible base was formed.

23. The invention as defined in claim 19 wherein said curling step further comprises the step of heating, at least in part, said flexible base.

24. The invention as defined in claim 19 further comprising the step of mounting on said flexible base at least one other circuit element.

25. The invention as defined in claim 24 wherein said at least one other circuit element is an integrated circuit.

26. The invention as defined in claim 24 wherein said least two of said conductive elements whose oppose ends meet to form a single curled wire are adjacent ones of said conductive elements.

27. The invention as defined in claim 24 wherein said wherein said conductive elements are made at least in part of metal.

28. The invention as defined in claim 24 further comprising the step of bonding said opposite ends of said at least two of said conductive elements that meet to form said single curled wire.

29. The invention as defined in claim 28 wherein said bonding step comprises the step of flowing solder.

30. The invention as defined in claim 28 wherein said bonding step comprises the step of heating said ends that meet and applying pressure thereto.
